(19) United States
(12) Patent Application Publication
(10) Pub. No.: US 2026/0252509 A1
(43) Pub. Date: Aug. 27, 2026

(54) MULTI-CHANNEL DYNAMIC RANDOM ACCESS MEMORY (DRAM) LATENCY OPTIMIZATION WITH DATA INTERFACE MULTIPLEXING

(71) Applicant: Rambus Inc., San Jose, CA (US)

(72) Inventors: Steven C. Woo, Saratoga, CA (US); Brent Steven Haukness, Sunnyvale, CA (US); Michael Raymond Miller, Raleigh, NC (US)

(21) Appl. No.: 19/419,574

(22) Filed: Dec. 15, 2025

Related U.S. Application Data
(60) Provisional application No. 63/763,573, filed on Feb. 26, 2025.

(51) Int. Cl. G06F 13/28; G06F 13/16

(52) U.S. Cl. CPC G06F 13/287; G06F 13/1678; G06F 13/1689

(57) ABSTRACT

A dynamic random access memory (DRAM) device includes an array of DRAM storage cells organized into multiple channels and request interface circuitry corresponding to the multiple channels. The request interface circuitry includes multiple request ports. Data interface circuitry corresponds to the multiple channels and includes multiple data ports. During a first type of memory access operation, each of the multiple request ports provides for a respective data transfer comprising a first width and a first burst length over each of the multiple data ports. During a second type of memory access operation, any one of the multiple request ports provides for a combined data transfer comprising a second width and a second burst length over a corresponding one of the multiple data ports that is combined with at least a second one of the multiple data ports.

### CROSS-REFERENCE TO RELATED APPLICATIONS

This application is a Non-Provisional that claims priority to U.S. Provisional Application No. 63/736,573, filed Dec. 19, 2024, entitled MULTI-CHANNEL DYNAMIC RANDOM ACCESS MEMORY (DRAM) LATENCY OPTIMIZATION WITH DATA INTERFACE MULTIPLEXING, which is incorporated herein by reference in its entirety.

### TECHNICAL FIELD

The disclosure herein relates to memory systems, memory controllers, memory devices, and associated methods.

### BRIEF DESCRIPTION OF THE DRAWINGS

Embodiments of the disclosure are illustrated by way of example, and not by way of limitation, in the figures of the accompanying drawings and in which like reference numerals refer to similar elements and in which:

FIG. 1 illustrates one embodiment of a memory system that employs host memory control circuitry, and at least one memory device.

FIG. 2 illustrates one embodiment of the channel multiplexing logic of FIG. 1.

FIG. 3A illustrates a block diagram for one embodiment of a read data packet transfer performed by the memory system of FIG. 1 during a first mode of operation.

FIG. 3B illustrates a block diagram for one embodiment of a read data packet transfer performed by the memory system of FIG. 1 during a second mode of operation.

FIG. 4 illustrates one specific embodiment for a communication scheme between memory controllers of different memory channels to coordinate data interface sharing between channels.

FIG. 5 illustrates one embodiment of a command truth table that incorporates bits indicating whether data interface bits are being borrowed for a given data transfer operation.

FIG. 6 illustrates a flowchart of steps for one embodiment of a method of operating the host memory control circuitry of FIG. 1.

FIG. 7 illustrates a flowchart of steps for one embodiment of a method of operating the at least one memory device of FIG. 1.

FIG. 8 illustrates one embodiment of a high-bandwidth memory (HBM) device that may be incorporated into the memory system of FIG. 1.

### DETAILED DESCRIPTION

Memory devices, modules, controllers, systems and associated methods are disclosed. In one embodiment, a dynamic random access memory (DRAM) device is disclosed that includes an array of DRAM storage cells organized into multiple channels and request interface circuitry coupled to the multiple channels. Data interface circuitry corresponds to the multiple channels and includes multiple data ports. During a first type of memory access operation, request interface circuitry provides for a respective data transfer comprising a first width and a first burst length over each of the multiple data ports. During a second type of memory access operation, the request interface circuitry provides for a combined data transfer comprising a second width and a second burst length over a corresponding one of the multiple data ports that is combined with at least a second one of the multiple data ports. For some embodiments, channel multiplexing circuitry is coupled to the multiple data ports to select between a first operating mode that is compliant with the first type of memory access operation or a second operating mode that is compliant with the second type of memory access operation. In some embodiments, during the second type of memory access operation, the second width is wider than the first width, and the second burst length is shorter than the first burst length. By selectively employing the combined data transfer over multiple data ports, reductions in transport latency may be realized, resulting in overall reduced latency parameters.

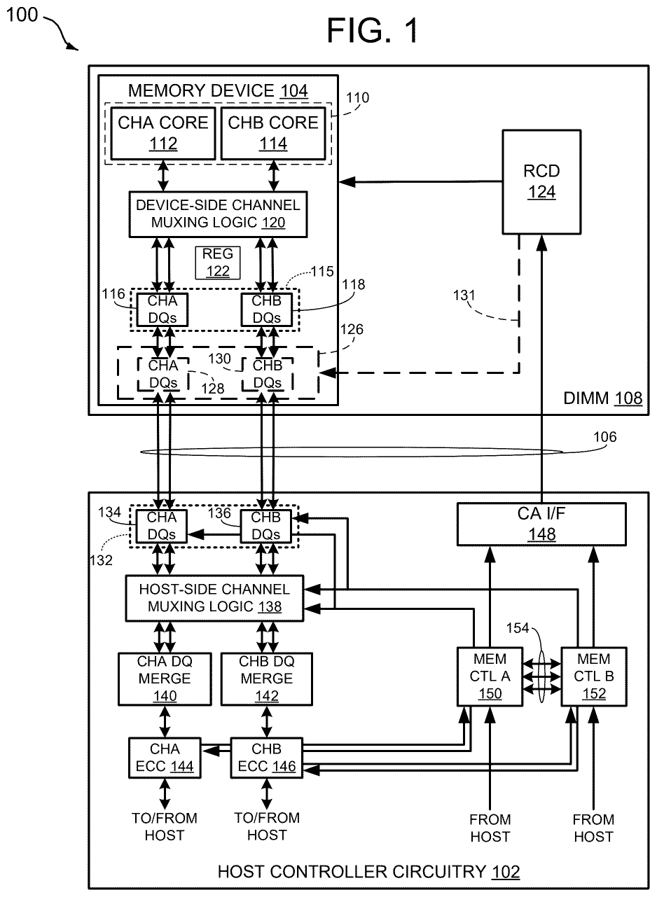

Referring now to FIG. 1, a memory system, generally designated 100, is shown that includes host memory control circuitry 102 coupled to one or more memory devices 104 via signaling media 106. In various embodiments disclosed herein, the memory system 100 is generally partitioned into multiple channels that are capable of independently carrying out multiple independent memory transactions. As more fully disclosed below, during a given data transfer situation, a given channel may selectively borrow resources from one or more other channels in an effort to reduce latency associated with the data transfer.

Further referring to FIG. 1, for some embodiments, the one or more memory devices 104 take the form of dynamic random access memory (DRAM) devices that are compliant with various DRAM standards, including double data rate (DDR) variants, low power (LPDDR) versions, high bandwidth (HBM), and graphics (GDDR) types. The one or more memory devices 104 may be coupled to a substrate to form a memory module 108, such as a dual inline memory module (DIMM) or multiplexed rank dual inline memory module (MRDIMM). In some embodiments, such as those associated with mobile systems, the memory devices 104 may be attached directly to the memory control circuitry 102, whether through soldered contacts or through stacked packaging techniques.

With continued reference to FIG. 1, for one embodiment, each memory device 104 includes memory core circuitry 110 that is partitioned into channel A core circuitry 112 and channel B core circuitry 114. Each memory device 104 also includes data interface circuitry 115, often referred to as DQ or input/output (I/O) interface circuitry, that is organized into channel A data interface circuitry 116 and channel B data interface circuitry 118. Device-side channel multiplexing logic 120 provides a switchable interface that allows for selectively sharing data transfer resources, such as the I/O circuitry, between channels as more fully described below. While the channel multiplexing logic 120 is shown in FIG. 1 as being interposed between the core circuitry 112, 114 and the data interface circuitry 116, 118, other embodiments may place the channel A data interface circuitry 116 and the channel B interface circuitry 118 between the core circuitry 112, 114 and the channel multiplexing logic 120.

In one embodiment, each memory device 104 includes mode register circuitry 122 to store a mode value, in response to receiving, for example, a mode register write (MRW) command, indicating whether a first mode of operation that maintains channel partitioning between I/O resources is in effect, or whether a channel I/O sharing mode of operation is selected for a given sequence of data transfers.

For some embodiments where the DIMM 108 is employed, a registered clock driver (RCD) circuit 124 may be utilized to distribute command/address signals and timing signals across one or more ranks of memory devices 104. In certain embodiments, each channel of each memory device 104 includes a dedicated CA port (not shown) to receive CA signals from the RCD circuit 124. For other embodiments, the multiple channels may share a common CA port (not shown). In some situations, the RCD circuit 124 may be coupled to data buffer circuitry 126 that includes one or more data buffer circuits, such as at 128 and 130, that are interposed between host-side data interface circuitry 132 and the device-side channel multiplexing logic 120. In some embodiments, each data buffer circuit 128, 130 may be dedicated to a corresponding one of the multiple channels that are supported by each memory device 104.

For one embodiment, the host-side data interface circuitry 132 employs data I/O resources in the form of host-side data ports 134 and 136 that generally correspond to each channel CHA and CHB. Host-side channel multiplexing logic 138 provides a switching interface for selectively steering and/or merging data involving I/O resources of multiple channels in the event a second channel's resources are being borrowed for a given data transfer. Data merge circuitry 140 and 142 for each channel merges portions of read data transferred over multiple channel I/Os, and couples to ECC coder/decoder circuitry 144 and 146 for each channel to perform error encoding functionality for write data or error decoding functionality for read data, depending on the operation involved. Command/address (CA) circuitry 148 provides a host-side CA port to transfer command, address and control information to the RCD circuit 124 of the DIMM 108.

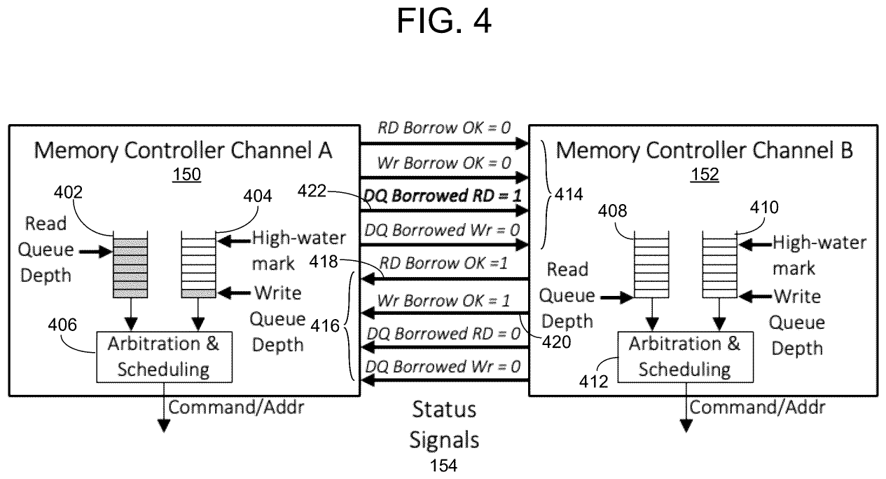

For one embodiment, multiple integrated circuit (IC) memory controllers 150 and 152 are employed by the host memory control circuitry 102 to independently control the memory channels CHA and CHB. As described below, for some operating situations, the memory controllers 150 and 152 cooperate to enable resource sharing between channels to reduce latency. For one embodiment, the memory controllers 150 and 152 may communicate with each other via a communications bus 154. The communications bus 154 generally passes status signals between the memory controllers 150 and 152 in an effort to optimally schedule memory-related transactions with channel resource borrowing in mind, as opportunities arise. Further detail regarding the status signals is described below with respect to FIG. 4.

In one embodiment, each memory controller 150 and 152 takes the form of a dynamic random access memory (DRAM) controller. In some embodiments, the host memory control circuitry 102 may be embodied as a discrete integrated circuit (IC) device, or chip. Other embodiments may realize the host memory control circuitry 102 as a circuit in a host central processing unit (CPU) (not shown), or as one or more controller chiplets that may be packaged with a CPU chiplet in a common chip package. In an embodiment one or more memory controllers may be disposed on an input/output (I/O) die along with the physical layer (PHY) e.g., transmitter/receiver circuits that interface to one or more memory device(s). Such an I/O die may include other types of I/O interfaces, as well as one or more chiplet interfaces that communicate with one or more respective CPU chiplet dies. The I/O die and CPU chiplet dies may be co-packaged together and coupled to one-another via a silicon interposer.

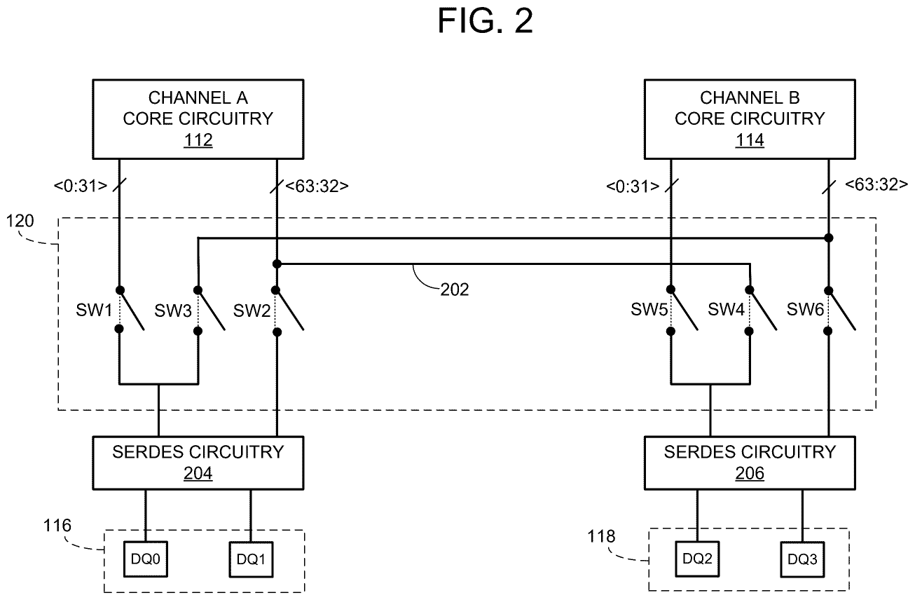

FIG. 2 illustrates one specific embodiment of the device-side channel multiplexing logic 120 that may be employed on each memory device 104. The device-side channel multiplexing logic 120 includes a switch matrix that is configurable depending on which mode of operation is being selected for a given data transfer. Generally, for a first mode of operation that maintains channel partitioning between data transfer resources, the switch matrix is configured such that the data associated with a given channel is routed using I/O circuitry solely associated with that channel. Thus, during the first mode of operation for a read operation involving solely the channel A channel I/O circuitry 116, a first switch SW1 and a second switch SW2 associated with channel A will be set to a closed state (indicated by dotted lines), with a third switch SW3 configured to an open state. For a second mode of operation, where channel I/O resource sharing between channels is employed, the same read operation directed to channel A will again have the first switch SW1 set to a closed state, but will have the second switch SW2 placed in an open state along with a fourth switch SW4, associated with channel B, configured to a closed state. The result of the switch matrix configuration during the second mode of operation is that a first portion of the data transfer is steered along channel A, via the first switch SW1, while a second portion of the read data transfer operation is directed to channel B, via the path 202 enabled by the open second switch SW2 and the closed fourth switch SW4. The remaining switches SW5, SW6 and SW3 generally operate in a similar fashion for situations where the read data transfer is primarily directed to channel B during the second mode of operation. The specific switch matrix topology shown in FIG. 2 is but one embodiment to accomplish the configurability functions described above, with other circuit topologies also envisioned.

For some embodiments, the number of internal I/O paths coupled to the core circuitry is much higher than the available number of external I/O paths. Serializer/deserializer (SerDes) circuitry 204 for channel A, and SerDes circuitry 206 for channel B serializes read data transferred from the respective core circuitry to the channel I/O circuitry. For the specific example of FIG. 2, read data from each channel core circuitry 112, 114 along sixty-four internal I/O paths are serialized by each SerDes circuit 204, 206 down to two paths, for a total width of four.

For some embodiments, the host-side channel multiplexing logic 138 includes switching circuitry similar to that described above for the device-side channel multiplexing logic 120, with switch configurations corresponding to those of the device-side channel multiplexing logic 120 to either maintain the channel partitioning of the read data transfer during the first mode, or merging the data portions from each of the channels, during the second mode of operation, to restore the original packet of data to the originating channel. For write transactions, the direction of data transfer is opposite that of read transactions, with the switching configurations for write operations generally matching those for read operations.

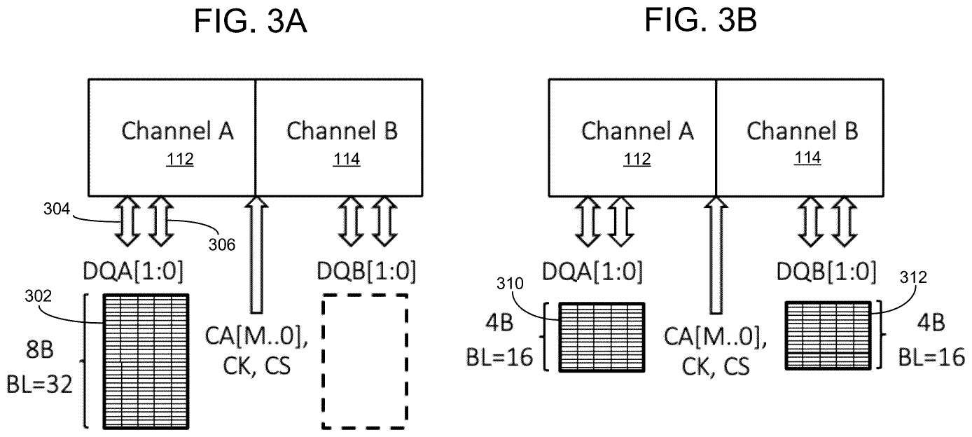

FIG. 3A illustrates the transfer of a data packet 302 with the host-side and device-side channel multiplexing logic 120 and 138 configured in a legacy partitioned mode of operation where no sharing between the I/O circuitry of different channels takes place for a given memory operation. Here, for a given transaction directed to the channel A core circuitry 112, an entire packet payload's worth of data, here eight bytes (sixty-four bits), is transferred along two I/O paths 304 and 306 (corresponding to a by-2 width), with a burst length BL of thirty-two bits per I/O path. In this example, the I/O resources for channel B are shown as idle, with no data being transferred, at 308.

FIG. 3B illustrates how the channels may take advantage of channel B's inactivity to transfer a first portion of channel A's data, at 310, and a second portion of the data associated with channel A, along the I/O resources of channel B, at 312. Since less data is transferred by each of the channels, but over the same I/O width, the burst length for each of the data portions may be reduced. For the specific example of FIG. 3B, half the data associated with channel A is steered to the borrowed I/O resources of channel B, such that for the by-two I/O interfaces, the burst length for each data portion is sixteen bits per I/O path.

While the specific circuitry shown in FIGS. 1, 2, 3A and 3B show a memory system with two channels, systems having any number of channels may benefit from the selective borrowing of other channel I/O resources to reduce data transport latency. Thus, four-channel, eight-channel, sixteen-channel and even thirty-two-channel embodiments may employ I/O sharing between two or more channels to reduce latency.

Depending on the application, the switching matrix 202 for the device-side channel multiplexing logic 120 and the host-side channel multiplexing logic 138 may be configured and controlled in a variety of ways.

FIG. 4 illustrates further detail for one embodiment of the controller-to-controller configuration of FIG. 1, with the first memory controller 150 coupled to the second memory controller 152 via the communications bus 154. As explained above, the first memory controller 150 controls memory transactions for channel A, while the second memory controller 152 generally controls memory transactions for channel B. The first memory controller 150 includes a read queue 402 to buffer read requests and a write queue 404 to buffer write requests. The read and write queues 402 and 404 feed into an arbitration and scheduling circuit 406 which schedules and generates commands, addresses and control signals for dispatching to the memory device 104 via the CA interface 148. The second memory controller 152 includes similar queues, at 408 and 410, and an arbitration and scheduling unit 412.

Further referring to FIG. 4, one embodiment of the communications bus 154 provides a first set of status signal paths 414 from the first memory controller 150 to the second memory controller 152 that provide status signals that generally indicate the level of traffic over the channel, and whether channel resource borrowing by channel A has occurred. The communications bus 154 includes a second set of status signal paths 416 from the second memory controller 152 to the first memory controller 150 that provides status signals that generally indicate the level of traffic over channel B, and whether resource borrowing by channel B has occurred. For the specific example shown in FIG. 4, the read queue 402 for the first memory controller 150 (channel A) is relatively full, with both queues 408 and 410 of the second memory controller 152 (channel B) being relatively idle. The second memory controller 152 indicates that it is able to lend channel I/O resources for read and write transfers, via status signals at 418 and 420. The first memory controller 150 may then confirm its intention to borrow the I/O resources for a read transfer via another status signal, at 422, and for one embodiment, sets a bit in a command packet indicating that read data is being transferred on I/O resources belonging to multiple channels. Note that while the arrangement of the memory controllers 150 and 152 in FIG. 4 has them directly connected via the communications bus 154, other embodiments may employ an intermediate circuit that may arbitrate and/or provide handshaking functionality for the controllers 150 and 152 to communicate with each other.

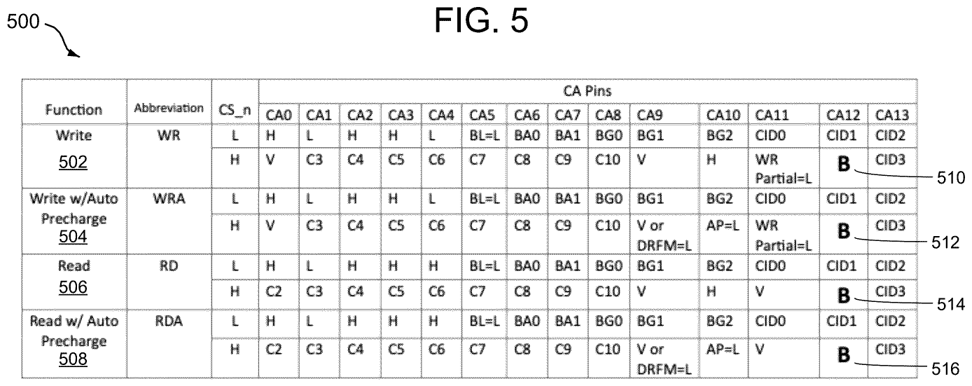

FIG. 5 illustrates one embodiment of a command packet truth table, generally designated 500, that is consistent with a DDR5 dual-channel DRAM memory system. For various functions, including write 502, write with auto precharge 504, read 506, and read with auto precharge 508, fields are provided for setting a state of “borrow” bits, such as at 510, 512, 514, and 516, to indicate to the memory device RCD circuit 124 (FIG. 1) whether I/O resources from the other channel will be borrowed for the given function or operation.

For some embodiments, rather than employing borrow bits in the command protocol, the logic utilized in the host memory control circuitry 102 and each memory device 104 may act on implicit rules or predefined criteria to switch between modes of operation such that channel I/O resource borrowing may be selectively employed as certain criteria are satisfied. For example, one implicit agreement might be associated with a condition where anytime one channel receives a read command, and little to no activity is occurring in the other channel, then borrowing of the idle channel's I/O resources may occur. Another example of an implicit agreement to share I/O resources between channels might involve a recognition of a timing “bubble”, where a channel may be subject to a memory core-related timing constraint preventing data from being transferred during the pendency of a timing interval for a memory access associated with that channel (such as a per-bank access timing constraint). Rather than remain idle due to the timing constraint, the I/O resources for the channel may be borrowed by another channel during the “bubble” window. Other rules may be based on, for example, priority data transfer situations, and so forth. By adopting an implicit set of rules corresponding to desired predefined criteria, a reduction in the command packet bandwidth may be realized by avoiding the use of “borrow” bits in the command packet.

In operation, the performance of a given memory system often relies on a variety of factors, including the interrelationship between latency and achievable bandwidth. Under relatively low-load conditions, where the actual bandwidth of the system is relatively low, the transport latency component of overall latency may be reduced through selective borrowing of I/O resources between channels utilizing the circuitry described above and shown in FIGS. 1 through 5.

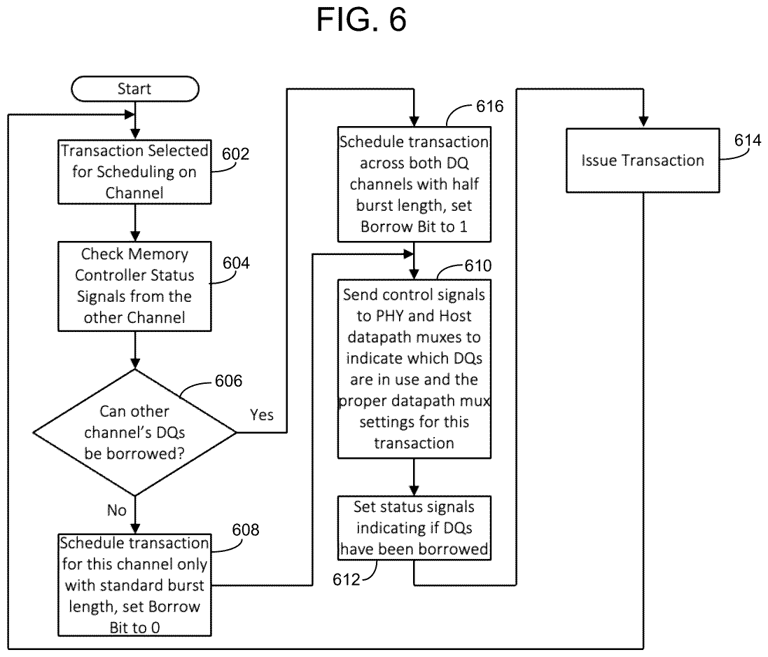

FIG. 6 sets forth steps employed for one embodiment of a method of operating each one of the memory controllers 150 and 152, during a read operation, in a memory system similar to the one shown in FIGS. 1 through 5. Write operations employ similar steps, but for data transfers from a given one of the memory controllers 150, 152 to the DIMM 108. As discussed above, each of the memory controllers 150 and 152 controls data transfers for a particular channel. At 602, a given memory controller selects a transaction for scheduling on its memory channel. Memory status signals from the other memory controller are then checked, at 604, such that a determination may be made, at 606, as to whether the other channel I/O resources can be borrowed.

Further referring to FIG. 6, if the other channel's I/O's are actively transferring data and cannot lend I/O resources, then the transaction is scheduled solely for the originating channel, with a standard burst length, and with the command packet indicating a state of the “borrow” bit for the transaction to a “0” state, at 608, to inform the RCD circuitry 124 that no channel I/O sharing will be taking place for the transaction. Control signals are then sent by the memory controller, at 610, to configure the host-side channel multiplexing logic 138 and the device-side channel multiplexing logic 120 into the legacy “partitioned” channel mode for the transaction. The memory controller, such as 150, then sets one or more status signals indicating to the other memory controller(s) 152, whether any I/Os from the other channel have been borrowed, at 612. The transaction may then be dispatched to the memory device 104, at 614.

With continued reference to FIG. 6, in the event that the determination, at 606, reveals that I/O resources from the other channel can be borrowed, then the transaction is scheduled for transfer across both channels with half the burst length, and with the command packet indicating a state of the “borrow” bit for the transaction to a “1” state, at 616, to inform the RCD circuitry 124 that channel I/O sharing will be taking place for the transaction. Control signals are then sent by the memory controller, at 610, to configure the host-side channel multiplexing logic 138 and the device-side channel multiplexing logic 120 into the “borrowed” I/O channel mode for the transaction. The controller then sets one or more status signals indicating to the other memory controller(s) whether any I/Os from the other channel have been borrowed, at 612. The transaction command may then be dispatched to the memory device 104, at 614.

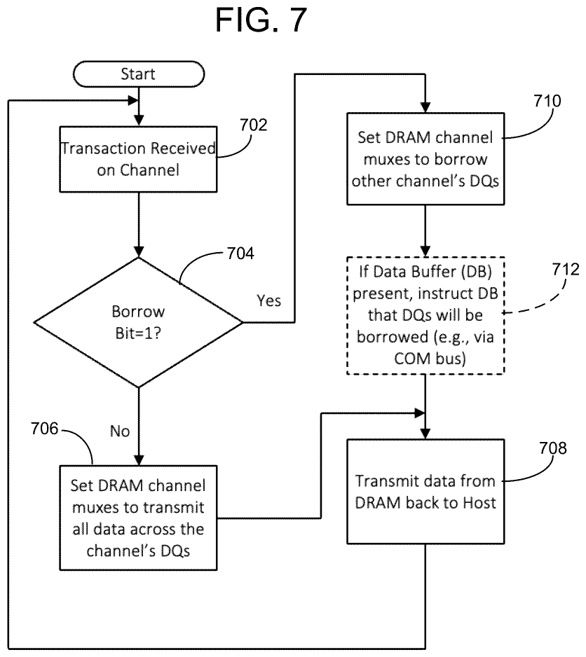

At the memory device side of the channel, and referring now to FIG. 7, once the transaction is received on the expected channel, at 702, a determination is then made, at 704, as to whether the state of the “borrow” bit for the transaction is a 0 or 1. If the borrow bit reflects a “0” state, indicating the legacy partitioned mode, then the device-side channel multiplexing logic 120 is configured to transmit all data across it's I/O resources, at 706, for solely its channel. The read data is then transmitted from the memory device 104 back to the host memory control circuitry 102, at 708.

Further referring to FIG. 7, in the event that the determination at 704 reveals that the “borrow” bit is set to a “1” state, then the device-side channel multiplexing logic 120 is configured to borrow the other channel's I/O resources, and transmit half the data across its channel I/O resources and half the data for transmission by the other channel's I/O resources, at 710. For embodiments where the data buffer circuits 128, 130 are employed on the DIMM 108, the RCD circuitry 124 instructs the data buffer(s), via a communication (COM) bus 131, that the I/O resources of the other channel will be borrowed for the transaction, at 712. The read data is then transmitted from the memory device 104 back to the host memory control circuitry 102, at 708.

The embodiments above are described and shown primarily in the context of double-data-rate (DDR)-based memory systems, such as DDR(N) variants, low-power DDR (LPDDR) systems, and graphics (GDDR) memory architectures, to name but a few. Stacked memory types such as High-Bandwidth Memory (HBM) and Hybrid Memory Cube (HMC) may also benefit from the selective channel sharing features described herein to reduce transport latency effects.

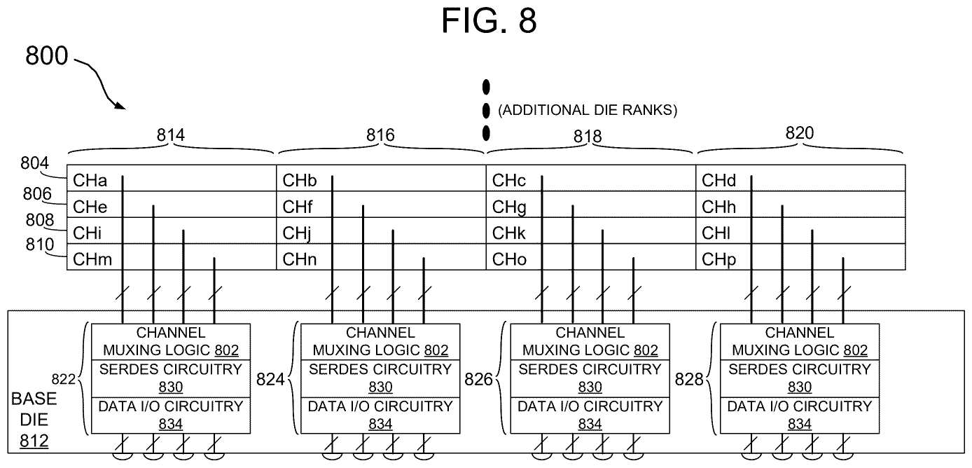

As an example, FIG. 8 illustrates a block diagram for one embodiment of an HBM device, generally designated 800, that employs channel multiplexing logic 802 similar to that described in FIGS. 1 and 2, to selectively configure I/O resources of multiple channels into a borrowing or sharing mode of operation. A first group of DRAM die 804, 806, 808, and 810 defining a first rank are vertically stacked on a logic base die 812. Each DRAM die, such as at 804, includes memory core circuitry that is partitioned into four channels, with the topmost die of the rank organized into channels CHa-CHd, the next lower die organized into channels CHe-CHh, and so on, for a total of sixteen channels associated with the first rank of die.

Further referring to FIG. 8, the base die 812 includes groups of support circuits 822, 824, 826, and 828, that correspond to the partitioned vertical groups of channels. Each support circuit includes the channel multiplexing logic 802 that is similar to that shown in FIGS. 1 and 2, but with a switch matrix to switch between four channels. Operation of the channel multiplexing logic 802 for each support circuit is similar to that described above in the DDR context. For some embodiments, each support circuit, such as at 822, includes SerDes circuitry 830 and data I/O circuitry 832. In other embodiments the switch matrix may switch between other numbers of channels such as two channels or eight channels. In another embodiment, the channel multiplexing logic 802 may be positioned between the SerDes circuitry 830 and the Data I/O Circuitry 834.

Those skilled in the art will appreciate the relatively straightforward circuitry for selectively borrowing data input/output (I/O) circuitry between memory channels for data transfer operations as described above. By employing channel multiplexing circuitry to selectively steer data between channels during data transfers, reductions in transport latency associated with the data transfers may be achieved.

When received within a computer system via one or more computer-readable media, such data and/or instruction-based expressions of the above described circuits may be processed by a processing entity (e.g., one or more processors) within the computer system in conjunction with execution of one or more other computer programs including, without limitation, net-list generation programs, place and route programs and the like, to generate a representation or image of a physical manifestation of such circuits. Such representation or image may thereafter be used in device fabrication, for example, by enabling generation of one or more masks that are used to form various components of the circuits in a device fabrication process.

In the foregoing description and in the accompanying drawings, specific terminology and drawing symbols have been set forth to provide a thorough understanding of the present disclosure. In some instances, the terminology and symbols may imply specific details that are not required to practice aspects of the disclosure. For example, any of the specific numbers of bits, signal path widths, signaling or operating frequencies, component circuits or devices and the like may be different from those described above in alternative embodiments. Also, the interconnection between circuit elements or circuit blocks shown or described as multi-conductor signal links may alternatively be single-conductor signal links, and single conductor signal links may alternatively be multi-conductor signal links. Signals and signaling paths shown or described as being single-ended may also be differential, and vice-versa. Similarly, signals described or depicted as having active-high or active-low logic levels may have opposite logic levels in alternative embodiments. Component circuitry within integrated circuit devices may be implemented using metal oxide semiconductor (MOS) technology, bipolar technology or any other technology in which logical and analog circuits may be implemented. With respect to terminology, a signal is said to be “asserted” when the signal is driven to a low or high logic state (or charged to a high logic state or discharged to a low logic state) to indicate a particular condition. Conversely, a signal is said to be “deasserted” to indicate that the signal is driven (or charged or discharged) to a state other than the asserted state (including a high or low logic state, or the floating state that may occur when the signal driving circuit is transitioned to a high impedance condition, such as an open drain or open collector condition). A signal driving circuit is said to “output” a signal to a signal receiving circuit when the signal driving circuit asserts (or deasserts, if explicitly stated or indicated by context) the signal on a signal line coupled between the signal driving and signal receiving circuits. A signal line is said to be “activated” when a signal is asserted on the signal line, and “deactivated” when the signal is deasserted. Additionally, the prefix symbol “/” attached to signal names indicates that the signal is an active low signal (i.e., the asserted state is a logic low state). A line over a signal name (e.g., ‘<̅s̅i̅g̅n̅a̅l̅ n̅a̅m̅e̅>̅’) is also used to indicate an active low signal. The term “coupled” is used herein to express a direct connection as well as a connection through one or more intervening circuits or structures. Integrated circuit device “programming” may include, for example and without limitation, loading a control value into a register or other storage circuit within the device in response to a host instruction and thus controlling an operational aspect of the device, establishing a device configuration or controlling an operational aspect of the device through a one-time programming operation (e.g., blowing fuses within a configuration circuit during device production), and/or connecting one or more selected pins or other contact structures of the device to reference voltage lines (also referred to as strapping) to establish a particular device configuration or operation aspect of the device. The term “exemplary” is used to express an example, not a preference or requirement.

While aspects of the disclosure have been described with reference to specific embodiments thereof, it will be evident that various modifications and changes may be made thereto without departing from the broader spirit and scope of the disclosure. For example, features or aspects of any of the embodiments may be applied, at least where practicable, in combination with any other of the embodiments or in place of counterpart features or aspects thereof. Accordingly, the specification and drawings are to be regarded in an illustrative rather than a restrictive sense.

1. A dynamic random access memory (DRAM) device, comprising:
an array of DRAM storage cells organized into multiple channels;
request interface circuitry coupled to the multiple channels;
data interface circuitry corresponding to the multiple channels and comprising multiple data ports;
wherein, during a first type of memory access operation, the request interface circuitry provides for a respective data transfer comprising a first width and a first burst length over each of the multiple data ports; and
wherein, during a second type of memory access operation, the request interface circuitry provides for a combined data transfer comprising a second width and a second burst length over a corresponding one of the multiple data ports that is combined with at least a second one of the multiple data ports.

2. The DRAM device of claim 1, wherein:
the request interface circuitry comprises multiple independent request ports that correspond to the multiple channels.

3. The DRAM device of claim 1, wherein:
the request interface circuitry is shared by the multiple channels.

4. The DRAM device of claim 1, wherein:
during the second type of memory access operation, the second width is wider than the first width, and the second burst length is shorter than the first burst length.

5. The DRAM device of claim 1, further comprising:
channel multiplexing circuitry coupled to the multiple data ports to select between a first operating mode that is compliant with the first type of memory access operation or a second operating mode that is compliant with the second type of memory access operation.

6. The DRAM device of claim 5, further comprising:
register storage to store a first mode value that indicates operation in the first operating mode; and
wherein the register storage is to store a second mode value that indicates operation in the second operating mode.

7. The DRAM device of claim 5, wherein:
the channel multiplexing circuitry operates in accordance with the first operating mode in response to receiving a first command type; and
wherein the channel multiplexing circuitry operates in accordance with the second operating mode in response to receiving a second command type.

8. The DRAM device of claim 7, wherein:
the channel multiplexing circuitry selects between operating in accordance with the first operating mode or the second operating mode based on predetermined criteria.

9. The DRAM device of claim 7, wherein:
the predetermined criteria comprise at least one from an expected density of read operations and an expected usage bandwidth of the multiple channels.

10. The DRAM device of claim 5, wherein:
the array of DRAM storage cells is formed in a stack of multiple DRAM die; and
wherein the channel multiplexing circuitry is formed in a base die that is stacked with the stack of multiple DRAM die.

11. A method of operating a dynamic random access memory (DRAM) device, the DRAM device comprising an array of DRAM storage cells organized into multiple channels, the DRAM device comprising request interface circuitry coupled to the multiple channels and comprising multiple request ports, the DRAM device comprising data interface circuitry corresponding to the multiple channels and comprising multiple data ports, the method comprising:
providing, during a first type of memory access operation, by each of the multiple request ports, for a first data transfer comprising a first width and a first burst length over each of the multiple data ports; and
providing, during a second type of memory access operation, for a second data transfer comprising a second width and a second burst length over a corresponding one of the multiple data ports that is combined with at least a second one of the multiple data ports.

12. The method of claim 11, further comprising:
selecting, with channel multiplexing circuitry, between a first operating mode that is compliant with the first type of memory access operation or a second operating mode that is compliant with the second type of memory access operation.

13. The method of claim 12, further comprising:
storing, with register storage, a mode value that indicates operation in one of at least the first operating mode and the second operating mode; and
operating the channel multiplexing circuitry in response to the mode value.

14. The method of claim 12, further comprising:
operating the channel multiplexing circuitry in accordance with the first operating mode in response to receiving a first command type; and
operating the channel multiplexing circuitry in accordance with the second operating mode in response to receiving a second command type.

15. The method of claim 12, wherein:
selecting, with the channel multiplexing circuitry, between operating in accordance with the first operating mode or the second operating mode based on predetermined criteria.

16. The method of claim 15, wherein:
the selecting, with the channel multiplexing circuitry, is based on at least one of an expected density of read operations and an expected usage bandwidth of the multiple channels.

17. A controller integrated circuit (IC) device, comprising:
first channel circuitry comprising
first request interface circuitry;
a first data port;
second channel circuitry comprising
second request interface circuitry;
a second data port;
channel multiplexing circuitry, during a first operating mode, to receive a data transfer from at least one memory device comprising a first data width and a first data burst length over one of the first data port or the second data port; and
wherein, during a second operating mode, the channel multiplexing circuitry is to receive a combined data transfer from the at least one memory device comprising a second data width and a second data burst length over both the first data port and the second data port, wherein the second data width is wider than the first data width, and the second data burst length is shorter than the first data burst length.

18. The controller IC device of claim 17, further comprising:
command generation circuitry to dispatch, to the at least one memory device, a mode value that indicates operation in one of at least the first operating mode and the second operating mode.

19. The controller IC device of claim 18, wherein:
the channel multiplexing circuitry operates in accordance with the first operating mode corresponding to the command generation circuitry dispatching to the at least one memory device a first command type; and
wherein the channel multiplexing circuitry operates in accordance with the second operating mode corresponding to the command generation circuitry dispatching to the at least one memory device a second command type.

20. The controller IC device of claim 17, wherein:
the channel multiplexing circuitry is to select between operating in accordance with the first operating mode or the second operating mode based on pre-determined criteria.
